(19) United States
(12) Patent Application Publication
(10) Pub. No.: US 2018/0088263 A1
(43) Pub. Date: Mar. 29, 2018

(54) THERMOFORMED LIQUID CRYSTAL POLARIZED WAFERS AND METHODS OF PRODUCING

(71) Applicants: Murray Kendall Wilson, Yuma, AZ (US); Yuichi Ogawa, Rancho Palos Verdes, CA (US)

(72) Inventors: Murray Kendall Wilson, Yuma, AZ (US); Yuichi Ogawa, Rancho Palos Verdes, CA (US)

(21) Appl. No.: 15/688,815

(22) Filed: Aug. 28, 2017

Related U.S. Application Data
(60) Provisional application No. 62/494,934, filed on Aug. 26, 2016.

(51) Int. Cl. G02B 5/30; G02B 1/08; G02C 7/12

(52) U.S. Cl. CPC G02B 5/3016; G02C 7/12; G02B 1/08

(57) ABSTRACT

Described herein are improved thermoformed liquid crystal polarized wafers and methods of creating, and more specifically the utilization of an improved printed polarized crystal technology and wafer adhesion technology which enables the production of a polarized wafer capable of being thermoformed without a loss of alignment precision.

### CROSS REFERENCE TO RELATED APPLICATION(S)

This application claims the benefit of priority under 35 U.S.C. § 119(e) of U.S. Ser. No. 62/494,934, filed Aug. 26, 2016, the entire content of which is incorporated herein by reference.

### BACKGROUND OF THE INVENTION

### Field of the Invention

The present invention generally relates to an improved thermoformed liquid crystal polarized wafer and methods of creating, and more specifically to utilizing an improved printed polarized crystal technology and wafer adhesion technology which enable the production of a sealed wafer capable of being thermoformed without a loss of alignment precision.

### Background Information

Polarized sunglass lenses have been around since the 1930's and there have been several processes developed through the years of ways to develop and produce polarized coverings. Early work by Polaroid Corporation figured out a way to make crystals and align them with magnets by using Quinine sulfate, a product that is also used to cure Malaria. Polaroid later developed a way to create a new and better polarizer not using crystals the same way. This process would later turn into what the market knows today as PVA or Polyvinyl Alcohol. This process utilizes crystals laid across PVA and the PVA is stretched to about 4 times it length. Eventually crystals were eliminated and replaced with an Iodine.

Currently the process of stretching PVA and other like materials is still used in making polarized films around the world. There have been several attempts to improve the process via coating liquid crystals onto a lens and coating but these techniques have not been widely adopted because of their lack of increased quality associated with increased costs as compared to the stretched film process.

There are several major distributors throughout the world who sell polarized film for the sunglass industry. The process is done where large sheets of material are purchased from companies like Mitsubishi Gas and Chemical Japan. These distributors will buy in meters and cut the film to certain specified sizes. These films are generally are used in the PVA stretching process described above, none of these films uses Liquid crystals as embodied in the present invention.

These films are referred to in the industry as wafers and are co-molded onto existing lenses. The process of a wafer is to cut to a precise shape and ship to an end manufacture company like Oakley for example. Oakley buys the wafers from a supplier in Japan, and places the wafer inside their proprietary Oakley mold. The mold will then fill up with plastic such as polycarbonate, and create a fusion bond. The fusion bond usually takes place at high temperatures around the melting point of plastic. These temperatures vary by material and thickness but can be around 300-400 degrees Fahrenheit. This end product is what is called a molded polarized lens. Prior to 1990 the sunglass industry was using only what was known then as thermoformed polarized lenses. The problem with a thermoformed polarized lens was the optical quality was not very good.

Polarized lenses made through a stretching process, created various issues with quality optics. The beginning polarized lenses were thin and became thicker as time moved on. Mitsubishi Gas and Chemical makes what is called a 1.5 mm lens thermoformed. This today is considered a low-end polarized lens blank. These lenses when thermoformed past a certain radius or bend create prism or distortion to some people. These lenses can only be bent so far to where they don't pass ANSI requirements. ANSI is a standard that the eyewear industry uses and holds most manufactures to measure of quality.

More recent technologies utilize thin polarized film such as 0.6 mm thick and injection mold it to the back of a lens. The end result is that the plastic can be cast to shape, creating less distortion. Although this became a standard way to produce high quality polarized lenses. The lenses also had issues with delaminating lenses coming apart and certain glues and distortion in the stretched and heat formed polarized film. The problem with the polarized stretched film, was that it gets thermoformed over a sunglass lens and because most sunglasses have a curved shape such as spherical, topic, cylindrical, conical and more the film is forced to stretch over the curved material rather than be applied in a uniform way on a planar surface. With the liquid crystal, they have more of a tendency to be planar aligned on the surface rather than the PVA like material which is stretched over a curve. Thus, the liquid crystal allows for a higher quality covering and polarizing effect.

Unfortunately, the present methods of require either a trade off in cost of wafer or quality in polarized coverage. The embodied changes of the present invention allows for a high quality cost effective way of producing a polarized wafer additional embodiments relate to processes which allow for the wafers to be produced with less environmentally hazardous materials including water soluble films. Thus, embodiments include a higher quality polarized lens produced more cost efficiently and more eco-friendly.

### SUMMARY OF THE INVENTION

The embodiments of the present invention include methods for creating a transformable flat sheet wafer capable of being thermoformed into a curved sheet comprising: a first top flat sheet of plastic material, a second bottom sheet of plastic material; a printed polarized liquid crystal film coating; wherein the printed polarized film coating is adhered to either a bottom surface of the first top flat sheet or the top surface of the second bottom sheet of plastic material; wherein the polarized crystal coating is sandwiched between the first top flat sheet and the second bottom sheet; resulting in a polarized wafer; wherein the polarized wafer is thermoformed on a curved mandrel to produce a desired wafer curvature. Additional embodiments may include placing the wafer inside a mold to create a fusion of the first and second plastic materials to create a single lens blank wherein said blank is cleaned and all moisture is removed from between the first and second plastic sheets. Further additional embodiments may include applying adhesion agents for securely attaching the polarized crystals to the flat sheets of plastic material which are solvent based or water based. Yet further additional embodiments include utilizing either a thermotropic or lyotropic application of polarized crystals. Preferred embodiments utilize a lyotropic application of polarized liquid crystals.

Further embodiments of the present invention relate to a curved polarized lens wafer comprising a first top flat sheet of plastic material, a second bottom sheet of plastic material; a printed polarized liquid crystal film coating of either thermotropically or lyotropically applied liquid crystals; wherein the printed polarized film coating is adhered to either a bottom surface of the first top flat sheet or the top surface of the second bottom sheet of plastic material, wherein the polarized crystal coating is sandwiched between the first top flat sheet and the second bottom sheet; resulting in a polarized wafer; and wherein the polarized wafer is thermoformed on a curved mandrel to produce a desired wafer curvature. Additionally, the curved polarized lens wafer may be further fused and processed into a lens blank for either plano or corrective lenses.

The embodiments of the present invention start with a flat sheet of transparent plastic such as Lexan, Polycarbonate, TAC, Tri-Acetate, Polyamide, Polyurethane, Nylon, or a material of the like and coat the plastic with a Nano chemistry technology of thermotropically or lyotropically applied liquid crystals. The preferred technology utilizes Lyotropic Liquid crystal to create a polarizer for sun lenses. The polarizer liquid crystal coating generally has a light transmission between the range of 9% to 84%. The embodied polarizer may be used in Sunglasses, Optical Glasses for sun, Safety Glasses used in the sun and other human eye related products for polarized vision.

The embodied Liquid Crystal polarizer is incased between two sheets of plastic protecting the inside coating from damage such as scratching and other elements that could harm the optics. One side of the plastic is coated and the other sheet is laminated onto the other surface, which the coating is adhered to, which creates a sandwich or also called a wafer.

The wafer can be cut to any shape for left and right lens once it is laminated and protected from debris. The average shape would be rectangular or radius edges and left to right measure about 3 inches wide and 2 inches tall. This shape can vary in size due to many different sizes of eyewear plus or minus 1 inch in either direction. The top layer is plastic sheet and on the back side of the sheet is the liquid crystal coating or called the middle. No specific order is needed other than the coating is protected with a top and bottom sheet and the coating is between the two. The three parts create a bond with adhesive and become one piece of film with a range of thickness between 0.003 thousandths to 0.090 thousandths of an inch. The assembled wafer consists of a top and bottom layer of plastic with a liquid crystal coating in the middle held together by adhesive or glue.

The next step of the process is to shape the wafer into sphere, toric, cylinder, aspheric, ellipsoid, or any shape other than the flat original shape using heat. This process is called thermoforming and uses heat to change the shape of the plastic. The plastic is heated to any temperature below the melting point and is generally brought to a certain temperature 180-500 degrees Fahrenheit dependent on the composition and thickness of the sheet. The heated sheet softens and allows the wafer laminate to take shape of the mandrel the wafer is resting on. This creates a shape other than flat. The thermoforming bend with the liquid crystals within a middle layer provide an improved wafer that does not have the stretching and distortion effects or delaminating issues associated with other processes or wafers.

The thermoformed wafer may be ready to be used for sunglass depending on the thickness. The wafer can also be used in a co-injection process, where the thermoformed wafer is placed inside a mold and bonded with other plastic through a thermal liquid process or injection molding. The curved wafer is placed into a mold that matches the wafers shape substantially. This allows the liquid plastic to bond to the back surface of the wafer. When looking through the sunglass lens, the wafer would be on the exterior and the plastic injection material would be on the back-side.

The embodiments of the present invention improve the cost effectiveness and quality of polarized wafers. The embodiments of the present invention utilize a combination of liquid crystals aligned onto sheet material. The embodied process utilizes a flat sheet material as the substrate that receives the liquid crystals. These crystals are aligned onto the substrate being TAC, Polycarbonate, Nylon or other forms of plastic film material. Crystals are applied to make a polarized film in colors such as grey, blue, green, yellow and other colors. These colors vary in light transmission and light spectrum.

The advantages of the embodied wafers and processes for making for the sunglass market is that liquid crystals are laminated between two sheets of plastic and thermoformed into a wafer and this wafer can either be curved into a lens and uses or co-injected with a proprietary lens shape and molded to the proprietary lens. The lenses may be used for plano or corrective lenses either with co-injection or as curved blanks.

### BRIEF DESCRIPTION OF THE DRAWINGS

The principles of the present invention will be apparent with reference to the following drawings, in which like reference numerals denote like components:

FIG. 1 consists of FIGS. 1A-1F which are line drawings depicting the wafers and the embodied process of producing the wafers of the present invention.

### DETAILED DESCRIPTION OF THE INVENTION

Generally, the embodiments of the present invention comprise of better processes for creating an improved and more cost efficient polarized wafer. More specifically, starting with transparent film material and coating a layer of liquid crystals that align, creating a polarizing light. These two films are sandwiched together with the liquid crystal aligned in between the two sheets. This now creates a stack and is ready to be cut to size and then thermoformed with heat. This starts as a flat sheet and then is formed into a predetermined shape such as toric, spherical, cylinder or other optical curvatures that are known for viewing through sunglass frames.

The film is formed using a mandrel or tool to make a new shape other than flat. The wafer is then processed for injection molding such as drying to make sure there is no water inside the wafer. This is very important to make sure all moisture is free from the wafer before it can be injection molded.

The embodiments utilize a combination of liquid crystals of aligned onto sheet material. The process in includes a flat sheet material used as the substrate that will receive the liquid crystals. The polarized crystals are aligned onto the substrate which may be a plastic material such as TAC, Polycarbonate, Nylon or other forms of plastic film material. Crystals are applied to make a polarized film in colors such as grey, blue, green, yellow and other colors. These colors vary in light transmission and light spectrum.

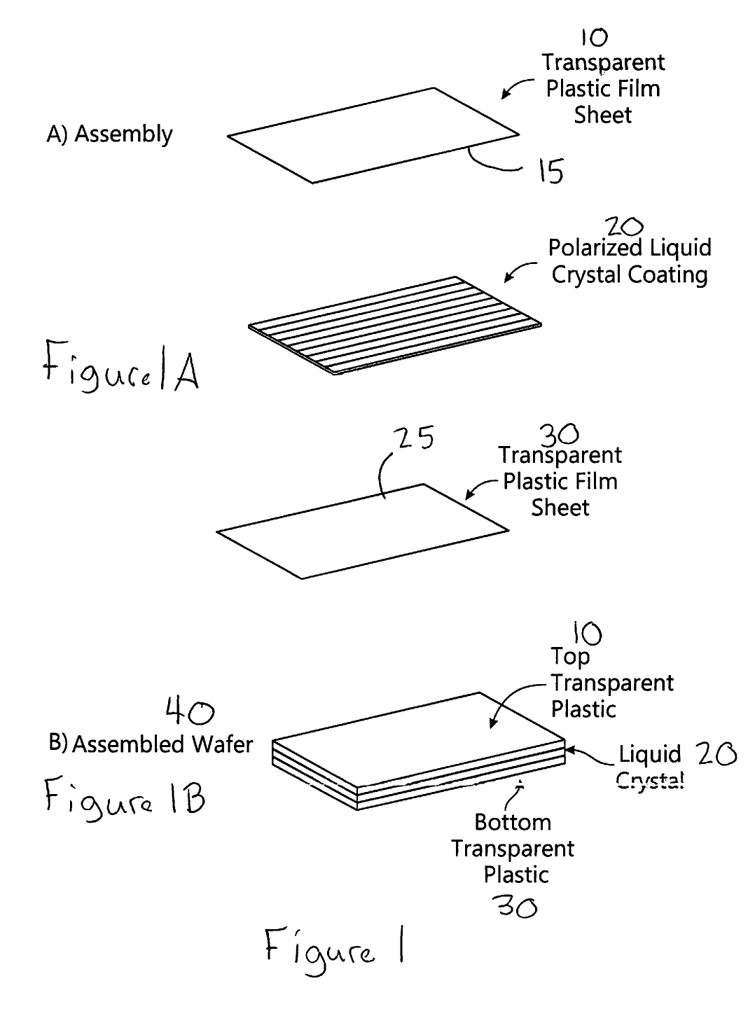

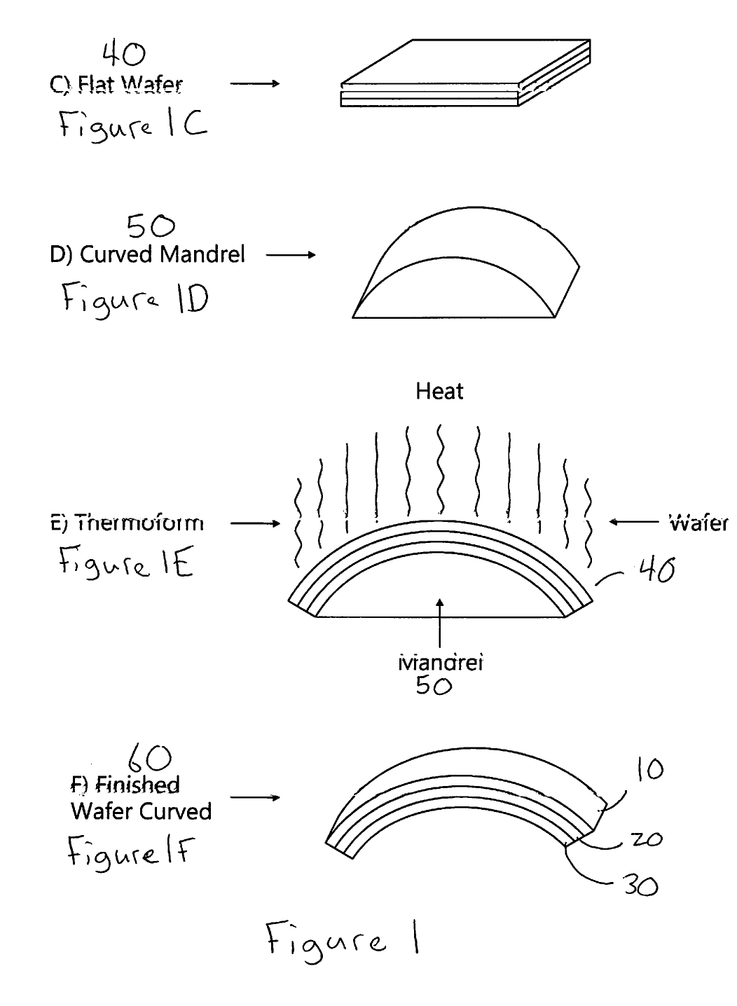

FIG. 1A shows that the process of making a better polarized wafer begins with a first flat sheet 10 and a second flat sheet 30 of transparent plastic such as Lexan, Polycarbonate, TAC, Tri-Acetate, Polyamide, Polyurethane, Nylon, or a material alike and coating it with a Nano chemistry technology such as Lyotropic Liquid crystal 20 to create a polarizer for sun lenses. The first flat sheet 10 has a bottom surface 15 which may be coated with the liquid polarizer coating 20 and the second flat sheet 30 has a top surface 25 which may also be coated with the liquid polarizer coating 20. The polarizer liquid crystal coating 20 has a light transmission between the range of 9% to 84%. The polarizer to be used in Sunglasses, Optical Glasses for sun, Safety Glasses used in the sun and other human eye related products for polarized vision.

FIG. 1B shows the Liquid Crystal polarizer layer 20 incased between the two sheets; top sheet 10 and a bottom sheet 30 of plastic protecting the inside polarized coating 20 from damage such as scratching and other elements that could harm the optics. One side of the plastic is coated and the other sheet is laminated onto the other surface, which the coating is adhered to, which creates a sandwich or also called a wafer 40.

FIG. 1C shows an embodied wafer 40 that can be cut to any shape for left and right lens once it is laminated and protected from debris. The average shape would be rectangular or radius edges and left to right measure about 3 inches wide and 2 inches tall. This shape can vary in size due to many different sizes of eyewear plus or minus 1 inch in either direction. The top layer is plastic sheet 10 and on the back side of the sheet 15 is the liquid crystal coating or called the middle 20. No specific order is needed other than the coating 20 is protected with a top 10 and bottom 30 sheet and the coating 20 is between the two. The three parts create a bond with adhesive and become one piece of film/wafer 40 with a range of thickness between 003 thousandths to 0.090 thousandths. The assembled wafer 40 consists of a top 10 and bottom layer 30 of plastic with a liquid crystal coating 20 in the middle held together by adhesive or glue.

FIGS. 1D and 1E show the next steps in the process to shape the wafer 40 into spheric, toric, cylinder, aspheric, ellipsoid, or any shape other than the flat original shape using heat. This process is called thermoforming and uses heat to change the shape of the plastic. The plastic is brought to a certain temperature which softens and allows the wafer laminate 40 to take shape of the mandrel 50 the wafer 40 is resting on. This creates a shape other than flat or its as coated condition being flat. The embodied to bending by thermoforming a liquid crystal polarizer from a flat surface to a curved surface other than flat allows for the wafer 40 to be produced at a higher quality and in a more efficient or cost effective manner.

The resulting curve-shaped wafer 60 shown in FIG. 1F can now be used for sunglass depending on the thickness. The finalized wafer or blank can also be used in a co-injection process (not shown), wherein the thermoformed wafer is placed inside a mold and bonded with other plastic through a thermal liquid process or injection molding. This allows for the ordered polarized blank to be adapted and injection molded with other proprietary or non-proprietary lens brands to produce a finale plano or prescription lens. The curved wafer is placed into a mold that matches the wafers shape substantially. This allows the liquid plastic to bond to the back surface of the wafer. When looking through the sunglass lens, the wafer would be on the exterior and the plastic injection material would be on the back side.

Although the invention has been described with reference to the above examples, it will be understood that modifications and variations are encompassed within the spirit and scope of the invention. Accordingly, the invention is limited only by the following claims.

1. A method for creating a transformable flat sheet wafer capable of being thermoformed into a curved sheet comprising:
a. a first top flat sheet of plastic material, a second bottom sheet of plastic material;
b. a printed polarized liquid crystal film coating;
c. wherein the printed polarized film coating is adhered to either a bottom surface of the first top flat sheet or the top surface of the second bottom sheet of plastic material;
d. wherein the polarized crystal coating is sandwiched between the first top flat sheet and the second bottom sheet; resulting in a polarized wafer;
e. wherein the polarized wafer is thermoformed on a curved mandrel to produce a desired wafer curvature.

2. The method of claim 1 further comprising placing the wafer inside a mold to create a fusion of the first and second plastic materials to create a single lens blank and wherein said blank is cleaned and all moisture is removed from between the first and second plastic sheets.

3. The method of claim 1 wherein the process includes applying adhesion agents for securely attaching the polarized crystals to the flat sheets of plastic material which are solvent based or water based.

4. The method of claim 3 wherein the process includes the application of water based adhesion agents.

5. The method of claim 1 wherein the process includes either the thermotropic or lyotropic application of polarized crystals.

6. The method of claim 3 wherein the process includes a lyotropic application of polarized crystals.

7. A curved polarized lens wafer comprising:
a. a first top flat sheet of plastic material, a second bottom sheet of plastic material;
b. a printed polarized liquid crystal film coating;
c. wherein the printed polarized film coating is adhered to either a bottom surface of the first top flat sheet or the top surface of the second bottom sheet of plastic material;
d. wherein the polarized crystal coating is sandwiched between the first top flat sheet and the second bottom sheet; resulting in a polarized wafer; and
e. wherein the polarized wafer is thermoformed on a curved mandrel to produce a desired wafer curvature.

8. The curved polarized lens wafer of claim 7 further comprising a lyotropic polarized crystal coating.

9. The curved polarized lens wafer of claim 8 further which has been fused and processed into a lens blank for either plano or corrective lenses.

10. A curved polarized lens wafer consisting of:
a. a first top flat sheet of plastic material, a second bottom sheet of plastic material;
b. a printed polarized liquid crystal lyotropic film coating;
c. wherein the printed polarized film coating is adhered to either a bottom surface of the first top flat sheet or the top surface of the second bottom sheet of plastic material;
d. wherein the polarized crystal coating is sandwiched between the first top flat sheet and the second bottom sheet; resulting in a polarized wafer;
e. wherein the polarized wafer is thermoformed on a curved mandrel to produce a desired wafer curvature; and
f. wherein the curved wafer has been fused and processed into a lens blank for either plano or corrective lenses.
